(19) United States
(12) Patent Application Publication
(10) Pub. No.: US 2012/0143397 A1
(43) Pub. Date: Jun. 7, 2012

(54) ASSET TRACKING SYSTEM AND METHOD

(75) Inventors: Gavin John Mackay, Somerset West (ZA); Lloyd Allan Marshall, Somerset West (ZA); Richard David Noel Timm, Midrand (ZA)

(73) Assignee: MIX TELEMATICS INTERNATIONAL (PROPRIETARY) LIMITED, Cape Town (ZA)

(21) Appl. No.: 13/387,596

(22) PCT Filed: Jul. 29, 2010
(86) PCT No.: PCT/IB2010/053447

§ 371 Date: Feb. 29, 2012

(30) Foreign Application Priority Data
Jul. 29, 2009 (ZA) 2009/05288

(51) Int. Cl. G06F 7/00

(52) U.S. Cl. 701/1

(57) ABSTRACT

An asset tracking system includes a central control station with an associated datastore for storing asset information. The stored information includes multiple unique identifiers, each identifier being associated with an asset tracking unit in the form of a mobile base station asset tracking unit or a beacon asset tracking unit. The two types of tracking unit are fitted to assets such as vehicles. The mobile base station asset tracking units include GPS modules and can determine their position, and can also communicate with the central control station. The beacon asset tracking units can communicate with the mobile base station asset tracking units via short range radio transmissions and their positions can thus be determined from the position of nearby mobile base station asset tracking units. The control station includes a communication module which can receive, over an existing communication network, location data messages from a mobile base station asset tracking unit fitted to a first asset. The message contains geographical location data on the first asset generated by the mobile base station asset tracking unit as well as the unique identifier of the mobile base station asset tracking unit and the unique identifier of a beacon asset tracking unit fitted to a second asset in the vicinity of the first asset. A processor module at the control station extracts from the location data message the unique identifier of the beacon asset tracking unit and the geographical location data of the first asset and associates this information to record the geographical location of the second asset.

### BACKGROUND OF THE INVENTION

THIS invention relates to an asset tracking system and associated method. More specifically, this invention relates to a method and system to track vehicles.

Various systems have been developed to track stolen or hijacked assets such as vehicles thereby to allow owners of vehicles and security companies to recover such assets. Most of these tracking systems require a vehicle tracking unit to be fitted or installed in the vehicle. The unit is typically required to determine and communicate its geographical position to a central control room. The geographical information is sent to the control room at intervals or when the unit is polled by the system.

Generally, the vehicle tracking unit includes a location module to determine the position of the unit. This location module is either a Global Positioning System (GPS) receiver that uses existing GPS technologies to calculate the position of the unit and therefore the asset, or makes use of mobile device location technologies (e.g. GSM) or radio technologies employing a proprietary fixed network of radio beacons. In these cases, triangulation or trilateration is used to determine the asset's location. In some systems, a combination of technologies is used to enable tracking. The central control room uses the received information for further processing thereby to deliver tracking services.

The above described systems all require the implementation or use of network infrastructures and mobile tracking devices which are costly to employ and maintain. The high cost of deployment and maintenance results in high upfront costs which are passed on to subscribers of the system as high subscription and monthly fees. This ultimately creates a barrier to entry to new subscribers who are cost sensitive.

It is an object of the present invention to provide an alternative asset tracking system and method.

### SUMMARY OF THE INVENTION

According to a first aspect of the invention there is provided an asset tracking system, the system including:
a. a datastore storing asset information including multiple unique identifiers, each identifier being associated with an asset tracking unit in the form of a mobile base station asset tracking unit or a beacon asset tracking unit; and
b. controlling means, the controlling means comprising:
   i. a communication module to receive over an existing communication network a location data message from one of the mobile base station asset tracking units fitted to a first asset, the message comprising geographical location data on the first asset generated by the mobile base station asset tracking unit as well as the unique identifier of the mobile base station asset tracking unit fitted to the first asset and the unique identifier of a beacon asset tracking unit fitted to a second asset in the vicinity of the first asset; and
   ii. a processor module to extract from the location data message the unique identifier of the beacon asset tracking unit and the geographical location data of the first asset and to associate this information thereby to record the geographical location of the second asset.

The system may comprise multiple mobile base station asset tracking units as defined below, these tracking units forming a mobile base station network allowing communication between a beacon asset tracking unit and the controlling means when the beacon asset tracking unit is in the vicinity of any one of the mobile base station asset tracking units.

Optionally, the system may include a plurality of fixed base stations in communication with the controlling means through the existing communication network and further operable to communicate with a beacon asset tracking unit wirelessly, preferably over a short-range radio frequency link.

The system may further comprise multiple beacon asset tracking units, each unit comprising a short range communication module to transmit its unique identifier to a mobile base station asset tracking unit or fixed base station when in its vicinity.

Each beacon asset tracking unit may be configured to operate in a recovery mode during which distress messages are transmitted to a mobile base station asset tracking unit in its vicinity.

The location data message may include additional distress information obtained from the distress messages.

The short range communication module of the beacon asset tracking unit may additionally transmit status information to the mobile base station asset tracking unit which information is to be forwarded to the controlling means.

Preferably the short range communication module is a short range radio frequency transceiver. Alternatively, the short range radio communication module may be a short range frequency transmitter and receiver.

According to a second aspect of the invention there is provided a mobile base station asset tracking unit to be employed in an asset tracking system and to be fitted to a first asset, the unit including:
a first short range communication module to receive from a beacon asset tracking unit in use fitted to a second asset to be tracked over short range communication a unique identifier when the second asset is in the vicinity of the first asset;
a location module to determine the geographical location of the mobile base station asset tracking unit;
a processing module to generate a location data message comprising the geographical location data determined by the location module, as well as a unique identifier of the mobile base station asset tracking unit fitted to the first asset and the unique identifier of a beacon asset tracking unit fitted to a second asset that was in the vicinity of the first asset; and
a second communication module to transmit over an existing communication network the location data message to a controlling station.

According to a third aspect of the invention there is provided a mobile base station module to be fitted to an asset tracking unit employed in an asset tracking system, the unit including:
a first short range communication module to receive from a beacon asset tracking unit in use fitted to a second asset to be tracked over short range communication a unique identifier when the second asset is in the vicinity of the first asset;
an interconnecting module to connect the mobile base station module to the asset tracking unit thereby to obtain geographical location information from a location module of the asset tracking unit; and
a processing module to generate a location data message comprising the geographical location data determined by the location module, as well as a unique identifier of the mobile base station asset tracking unit fitted to the first asset and the unique identifier of a beacon asset tracking unit fitted to a second asset that was in the vicinity of the first asset, which is to be sent transmitted by a communication module of the asset tracking unit over an existing communication network to a controlling station.

Preferably the short range communication module is a short range radio frequency transceiver. Alternatively, the short range radio communication module may be a short range frequency transmitter and receiver.

The short range communication module may additionally receive status messages or distress messages from the beacon asset tracking unit which status information is sent to the control station.

Also, the short range communication module may receive distress messages from the beacon asset tracking unit when the unit is in a recovery mode. Distress information obtained from the distress messages may be included in the location data message.

Preferably, the short range communication module is to receive a command from the control means which is forwarded to the beacon asset tracking unit to place the beacon asset tracking unit in a recovery mode.

The processing module of the mobile base station asset tracking unit may be configured to place the mobile base station asset tracking unit in a recovery mode on receipt of a distress command from the control means, in which mode the short range communication module transmits distress signals to other mobile base station asset tracking units or fixed base stations within its vicinity and/or to other land, mobile or airborne recovery systems

The short range radio frequency transceiver may transmit polling messages which are received by any beacon asset tracking units in the vicinity of the mobile base station asset tracking unit, in response to which the beacon asset tracking unit is to transmit its unique identifier.

According to another aspect of the invention there is provided a method of tracking an asset, the method including:
providing a datastore storing asset information including multiple unique identifiers, each identifier associated with an asset tracking unit in the form of a mobile base station asset tracking unit or a beacon asset tracking unit;
receiving over an existing communication network a location data message from one of the mobile base station asset tracking units fitted to a first asset, the message comprising geographical location data on the first asset generated by the mobile base station asset tracking unit as well as the unique identifier of the mobile base station asset tracking unit fitted to the first asset and the unique identifier of a beacon asset tracking unit fitted to a second asset that was in the vicinity of the first asset; and
extracting from the location data message the unique identifier of the beacon asset tracking unit and the geographical location data of the first asset and associating this information thereby to record the geographical location of the second asset.

The method may further include providing a mobile base station network of multiple mobile base station asset tracking units fitted to the multiple first assets in order to allow communication between the beacon asset tracking unit and a control station via the mobile base station network whenever the beacon asset tracking unit is in the vicinity of any one of the mobile base station asset tracking units.

According to another aspect of the invention there is provided a method of tracking an asset with a mobile base station asset tracking unit to be employed in an asset tracking system and to be fitted to a first asset, the method including:
receiving from a beacon asset tracking unit fitted to a second asset to be tracked over short range communication a unique identifier when the second asset is in the vicinity of the first asset;
determining the geographical location of the mobile base station asset tracking unit;
generating a location data message comprising the geographical location data determined by the location module, as well as a unique identifier of the mobile base station asset tracking unit fitted to the first asset and the unique identifier of a beacon asset tracking unit fitted to a second asset that was in the vicinity of the first asset; and
transmitting over an existing communication network the location data message to a control station.

### BRIEF DESCRIPTION OF THE DRAWINGS

FIG. 1 is a schematic system diagram of an asset tracking system in accordance with an example embodiment of the present invention;

FIG. 2 is a functional block diagram of the components of a beacon asset tracking unit of the system of FIG. 1;

FIG. 3 is a functional block diagram of the components of a mobile base station asset tracking unit of the system of FIG. 1; and

FIG. 4 shows a data structure of information stored in a database of the system of FIG. 1, in accordance with an example embodiment of the present invention.

### DESCRIPTION OF EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details or any specific manner.

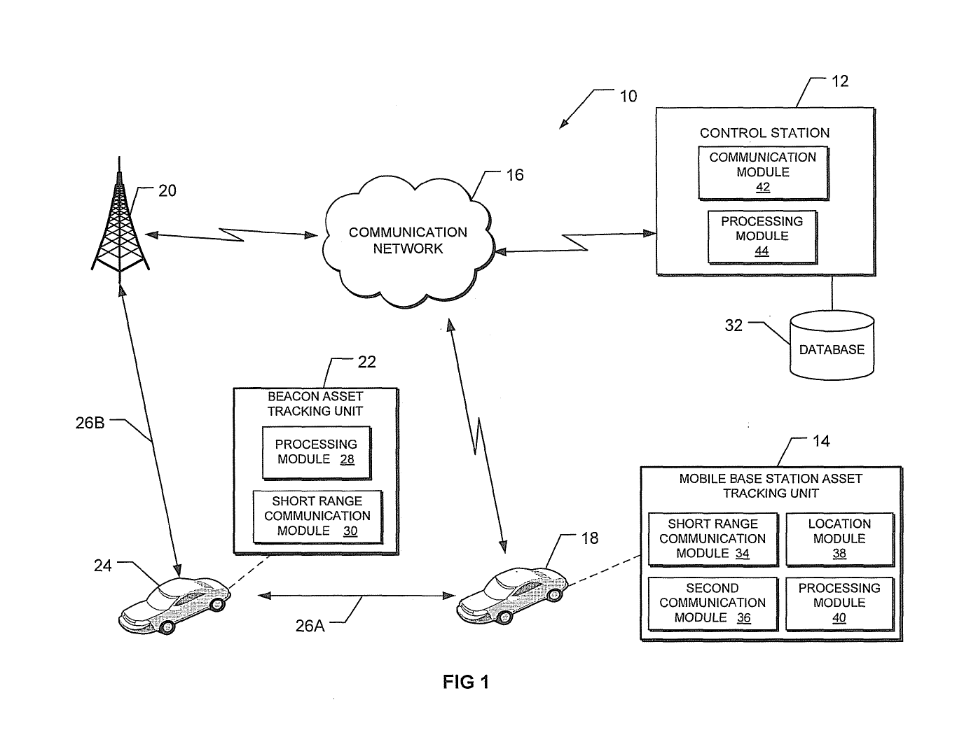

Referring to FIG. 1, an asset tracking system is shown in the form of a vehicle tracking system 10. Controlling means in the form of a control station 12 is in communication with multiple mobile base station asset tracking units, indicated by a mobile base station asset tracking unit 14, over an existing communication network 16. Each of the mobile base station asset tracking units 14 is fitted to an asset which is shown in FIG. 1 as a vehicle 18. Although only one of the units 14 is shown, it will be understood that a substantial number of the units may be used in the system.

The existing communication network 16 may comprise network infrastructure which allows the mobile base station asset tracking unit 14 to communicate its geographical location to the control station 12 at any given moment in time. In one example embodiment, the communication network 16 includes multiple fixed base stations, indicated by a tower 20 in FIG. 1. The fixed base stations may be, for example, mobile cellular telephone network towers, radio beacons forming a proprietary fixed network, or a suitable combination.

The multiple mobile base station asset tracking units provide a mobile base station network which is used by beacon asset tracking units, one of which is indicated by reference numeral 22. Each of these beacon asset tracking units 22 is fitted to a second type or group of assets indicated by a second vehicle 24 in the example embodiment of FIG. 1. As will become evident from the description below, the fixed base stations 20 are intended to supplement the coverage of the mobile base station communication network provided by the multiple mobile base station asset tracking units 14.

Again, for the sake of clarity, it should be understood that a typical example embodiment of the invention will utilize multiple fixed base stations 20 and may include numerous beacon asset tracking units 22.

The relevant beacon asset tracking unit 22 communicates with a respective mobile base station asset tracking unit 14 when the vehicle 24 is in the vicinity of the vehicle 18. Both units 14 and 22 are configured to communicate wirelessly, typically via radio communication, and preferably over a short range radio frequency link 26A, when the units 14 and 22 are in radio frequency range. Similarly, the beacon asset tracking unit 22 is able to communicate over a short range radio frequency link 268 with the fixed base station 20 whenever the unit 22 is in radio frequency range of the fixed base station 20.

The beacon asset tracking unit 22 comprises a processing module 28 and a short range communication module 30. A “module” in the context of the specification may be implemented in software, hardware, or a combination of software and hardware. In a prototype embodiment of the system, the processing module 28 comprises a PIC microcontroller 46 running proprietary software.

A unique identifier is assigned to the beacon asset tracking unit 22 in order to identify the unit within the system 10. The identifier is further associated with subscriber information which is stored in a database 32 at a central control station (see below). The unit 22 may be self-powered through an internal battery, in which case no wired connection to the vehicle 24 is required. Additionally or alternatively the unit may be wired to the battery supply circuit of the vehicle 24 for extended operational lifetime.

The short range communication module 30 may be a radio frequency transceiver (or a separate transmitter and receiver) capable of receiving or transmitting radio signals, that transmits data to any mobile base station asset tracking 14 or fixed base station 20 in its vicinity over the short-range radio frequency links 26A and 26B. The communication range of the module 30 may typically be in the range of a few meters up to approximately one kilometer.

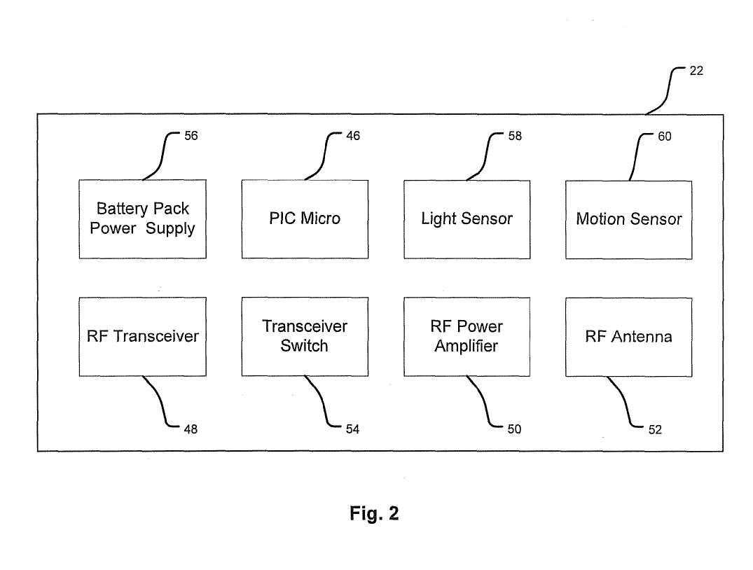

In the prototype embodiment of the system, the short range communication module 30 comprises an RF transceiver 50 with an associated RF power amplifier 52, an RF antenna 54, and a transceiver switch 56 which is operable to control the transceiver 50. The unit 22 is provided with a battery pack 56, and both a light sensor 58 and a motion sensor 60 connected to the microcontroller 46. The functional block diagram of FIG. 2 illustrates the components of the unit 22.

The beacon asset tracking unit 22 operates by transmitting its unique identifier at certain times which are determined by the motion sensor 60. The motion sensor is used to determine when the vehicle is moving, so that when the vehicle is travelling the beacon unit will transmit more often. This algorithm helps extend the life of the battery.

The unique identifier transmitted by the prototype beacon unit 22 is 12 bytes long and consists of a 32 bit ID code, the firmware version of the unit, a sequence number (used for the rolling code in the encryption system used) and other status information of the unit, such as its battery condition.

If a base station asset tracking unit 14 is within range of the beacon unit 22 when the beacon unit 22 transmits a message identifying itself, the base station unit 14 will then acknowledge the beacon unit's message in an acknowledgement message. The acknowledgment message includes information as to what the beacon unit should do. For example, if the beacon unit was on a list of stolen vehicles, the acknowledgment message will tell the beacon unit to go into a recovery mode to assist a recovery team to recover the vehicle.

The communication module 30 preferably operates in unlicensed frequency bands, for example at 433 MHz. The transmitting power output of the transmitter is limited by the maximum allowed for by law in the unlicensed bands but may be adjusted through software control to lower settings and thus less range. Software algorithms control the optimum power output to maintain an acceptable balance between battery life and reliable communications. An algorithm of operation is also intended to avoid frequency band clutter, for example where the close proximity of too many communication modules in the same geographical area can swamp the frequency band.

The data may be transmitted in the form of a message which comprises the unique identifier of the unit 22.

The radio frequency links 26A and 26B may be mono-directional in which case the short range communication module 30 would be configured to transmit data only. Alternatively the radio frequency links 26A and 26B may be bi-directional, in which case the short range communication module 30 would both transmit and receive data. The processing unit 28 may additionally encode and encrypt data prior to its transmission in a manner to make the wireless links 26A and 26B secure against external intervention and limit the effect of jamming devices.

It will be appreciated that the beacon asset tracking unit 22 may communicate its unique identifier in various modes to announce that it is in range or in the vicinity of the mobile base station asset tracking device 14 and fixed base station 20. In one mode of operation the unit 22 waits for a polling signal from the mobile base station asset tracking device 14 or fixed base station 20 before transmitting its unique identifier. In another mode of operation the unit 22 announces its presence by transmitting its unique identifier at regular, irregular or pre-determined intervals and then listens for a reply message from the mobile base station asset tracking device 14 and fixed base station 20. The unit 22 may also operate in a mode in which it transmits the unique identifier at intervals without awaiting a reply from the unit 14 or base station 20.

The unit 22 may also be placed in a recovery mode on instruction from the control station 12 or a recovery system (not shown). For example, a command may be sent to the processing module 28 of the unit 22 in the event that the vehicle 24 is hi-jacked or stolen, thereby to place the unit 22 in the recovery mode. A similar command may be sent to the unit to switch the recovery mode off.

A typical recovery system comprises of equipment and methods that can detect the direction from which radio frequency signals are received. It may also be configured to receive and decode any messages received from the communication module 30. Similarly, it may be configured to transmit messages in a protocol that can be decoded by the communication module 30. Recovery systems are usually fitted to the land based vehicles or aircraft, such as helicopters, of recovery crews.

The command signals are transmitted to the beacon asset tracking unit 22 over the radio frequency links 26A and 26B, either from one of the mobile base station asset tracking units 14, a fixed base station 20 or the recovery system itself.

In the recovery mode, the beacon asset tracking unit 22 may announce a distress or alarm condition by transmitting a uniquely identifiable modulated distress signal, transmitting a uniquely identifiable distress code other than its unique identifier, transmitting data at a predetermined pulse rate and/or frequency and/or transmitting data at a higher and/or lower power output level. Any of these transmissions would be deemed a distress signal by the control station 12 or the recovery system. It will be understood that other forms of encoding or modulation could be used in the distress signal.

Turning now to the mobile base station asset tracking unit 14, this unit 14 comprises a short range communication module 34, a second communication module 36, a location module 38 and a processing module 40. Similarly to the unit 22, the unit 14 also has a unique identifier assigned to it in order to identify the unit within the system 10 and in order to identify any data received from the unit 14. The unique identifier of the unit 14 is also associated with subscriber information which is stored in the database 32.

The short range communication module 34 is arranged to receive the unique identifier transmitted from the beacon asset tracking unit 22 when the vehicle 24 is in the vicinity of the vehicle 18. The short range communication module 34 is also configured to receive any other data, codes or signals that may be transmitted by the unit 22 over the short range communication link 26A. In one example embodiment, the short range communication module 34 is a short-range radio frequency module.

The location module 38 of the mobile base station asset tracking unit 14 determines the geographical location of the mobile base station asset tracking unit and therefore of the vehicle 18 to which it is fitted. In one example embodiment, the location module 38 may be a GPS (Global Positioning System) receiver. Alternatively, the location module 38 may be a system that relies on triangulation of radio signals from proprietary radio networks, or using the positions of GSM towers from third party networks to determine position.

The processing module 40 is configured to generate a location data message comprising the geographical location data determined by the location module 38, as well as the unique identifier of the unit 14 and the unique identifiers of any beacon asset tracking unit 22 fitted to vehicles that are in the vicinity of the vehicle 18. It will be appreciated that the location data message may be time-stamped in order to provide an indication of when the vehicle 24 was in the vicinity of the vehicle 18.

The second communication module 36 is configured to transmit this message and any other data messages over the existing communication network 16 to the control station 12. The communication module 36 will transmit the message in a format suitable to the existing communication network 16. For example a GPRS packet or an SMS message containing the relevant data could be sent via any third party GSM network or the packet of data may be transmitted via a proprietary RF network.

Other data messages that may be transmitted to the control station 12 may include status data received from the beacon asset tracking unit 22, e.g. to show whether or not the unit 22 is in the recover mode, and diagnostic data received from the unit, e.g. battery status information.

The mobile base station asset tracking unit 14 may also receive messages from the control station 12 and may forward these messages to the beacon asset tracking unit via its short range communication module 34. These messages may include commands or instructions to switch the unit 22 in or out of recovery mode, instructions to ignore and/or switch off specific beacon asset tracking units e.g. where services have been discontinued, and/or instructions to change the operational modes of the unit 22. It will be appreciated that these messages or instructions are to include the unique identifier of the unit 22 to which the messages are to be sent.

The processing module 40 of the unit 14 may also be configured to allow the short range communication module 34 to operate similarly to the short range communication module 30 of the beacon asset tracking unit 22. For example, the processing module 40 may place the unit 14 in a recovery mode, with the short range communication module 34 then transmitting distress signals to other mobile base station asset tracking units 14 or fixed base stations 20 within short-range radio communication range. The short range communication module 34 may also be configured to receive or transmit coded signals to and from ancillary devices of the vehicle 14, such as panic buttons, remote control units and driver and/or trailer identification devices.

It will be appreciated that the mobile base station asset tracking unit 14 may be a single unit which is fitted to a vehicle 18. Alternatively, the short range communication module 34 and the processing module 40 may form a mobile base station module or device that is added as an after-market fitment through a mechanical and electrical customised interconnecting module to an existing vehicle tracking unit.

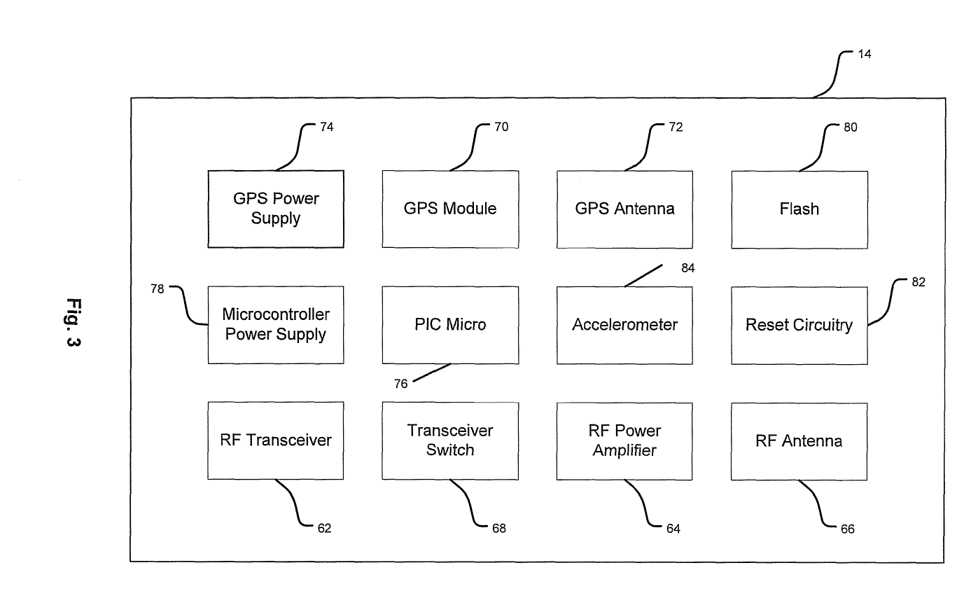

A prototype embodiment of the mobile base station asset tracking unit 14 is shown in greater detail in FIG. 3. The first and second communication modules 34 and 36 each include an RF transceiver 62, an RF power amplifier 64, an RF antenna 66 and a transceiver switch 68. The first communication module 34 operates at 433 MHz and provides a short range communication link to the beacon units 22. The second communication module 36 is a GSM modem providing a long range communication link to the control station 12. The location module 38 typically comprises a GPS module 70 with an associated antenna 72 and a dedicated power supply 74. The processing module 40 comprises a PIC microcontroller 76 with an associated power supply 78 which can comprise a battery or be arranged to use the vehicle power supply. The processing module includes flash memory 80 and reset circuitry 82. An accelerometer 84 is connected to an input of the microcontroller to provide a motion detection capability.

As shown by FIG. 1 the control station 12 includes a communication module 42 to communicate with the fixed base stations 20 and the mobile base station asset tracking units 14, as well as a processing module 44. In particular, the communication module 42 is configured to receive location data messages from the units 14, and any other status or diagnostic messages that may be transmitted via the units 14. Commands, such as to place a beacon asset tracking unit in recovery mode, may also be transmitted from the control station 12.

The processing module 44 is configured to process all information received from or to be transmitted to the units 14 or fixed base stations 20. For example, the processing module 44 extracts the unique identifier of a beacon asset tracking unit 22 and the geographical location data of the vehicle 14 thereby to find a geographical location of the vehicle 24. This information is accordingly associated and stored, e.g. in the database 32, thereby to record a geographical location of the vehicle 24. In the event that the vehicle 24 is stolen, the location of the vehicle 24 could then be tracked, even though there is no direct communication between the control station and the beacon asset tracking unit 22.

It is to be appreciated that the optimal operation of the system is dependent on a relatively high number of vehicles 18 being fitted with the mobile base station asset tracking units 14.

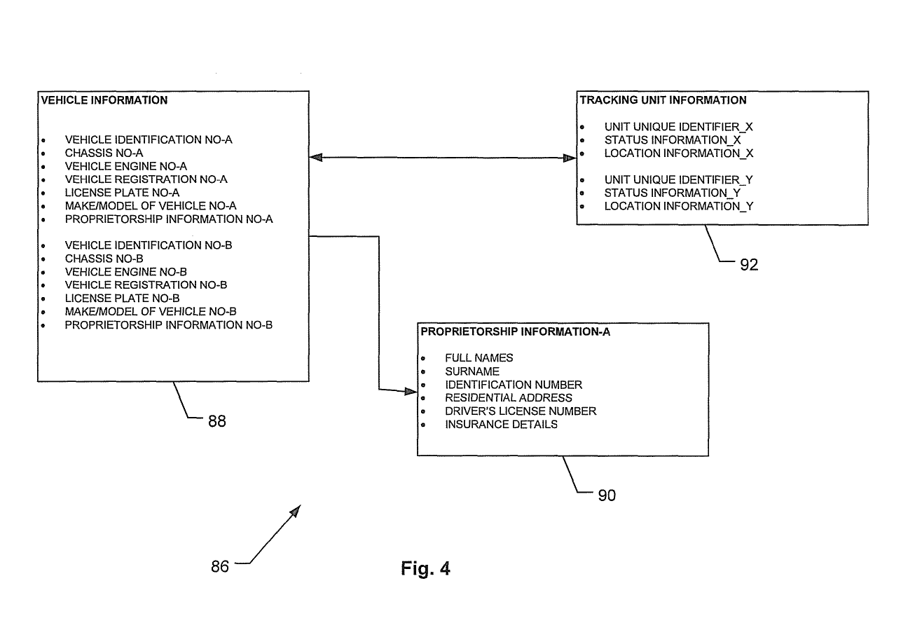

Referring now to FIG. 4, an example embodiment of data structures 86 of the database 32 are shown. The data is typically captured when a user subscribes to the asset tracking system. Vehicle or other asset information is captured to identify the asset to be tracked and to associate this asset with the relevant tracking unit. Vehicle information 88 may for example include a vehicle identification number (VIN) and/or chassis number, a vehicle engine number, a vehicle registration number, the make and/or model of the vehicle and proprietorship information 90 for a particular vehicle A. In an example embodiment the proprietorship record is associated with information of one or more vehicles.

The proprietorship information 90 may include personal details of the owner of the vehicle, for example the full names, surname, identification number or social security number, residential address of the owner of the motor vehicle, the driver's license number, insurance details, or the like.

Tracking unit information 92 is also stored in the database 32. This information includes the unique identifiers of all tracking units, i.e., both beacon asset tracking units 22 and mobile base station asset tracking units 14. This information is used to identify the tracking units and the information associated with such units, e.g., vehicle and proprietorship information. The unique identifiers are also used in order to record location information and status information of the units against such identifiers. It is evident that the processing module 44 of the control station 12 would be able to search the database 32 for any relevant information through the use of the unique identifiers. When a matching unique identifier is found, the vehicle information associated with the matching unique identifier will be retrieved and utilised as required.

The vehicle information 88 and the proprietorship information 90 may be captured and stored in the database 32 in any suitable manner, e.g. through interfaces that are web-enabled.

It will be appreciated that the present invention allows for the creation of a mobile base station communication network which can be used by relatively simple beacon asset tracking units to communicate and determine the geographical locations of the units and their associated assets. Essentially, the beacon asset tracking units “piggy-back” on the greater capabilities of the mobile base station asset tracking units. As the size of the mobile base station communication network increases, with more and more assets being fitted with mobile base station asset tracking units, the efficiency of the beacon asset tracking units and the system will improve. This is due to the fact that more mobile base station asset tracking units being fitted to vehicles would provide a higher probability of a particular beacon asset tracking unit being in the vicinity of a mobile base station asset tracking unit at any given time.

Although the invention has been described specifically in relation to a vehicle tracking system, it would be appreciated that the system could find application in other tracking environments. It should be appreciated that the invention may extend to applications where one beacon asset tracking unit 22 may have the capability to communicate to another beacon asset tracking unit 22 via a radio link not shown in the drawings but similar to 26A. In addition, any mobile base station asset tracking unit 14 may also be able communicate with another mobile base station asset tracking unit 14 via a radio link similar to 26A.

1. An asset tracking system, the system including:
a. a datastore storing asset information including multiple unique identifiers, each identifier being associated with an asset tracking unit in the form of a mobile base station asset tracking unit or a beacon asset tracking unit; and
b. controlling means, the controlling means comprising:
i. a communication module to receive over an existing communication network a location data message from one of the mobile base station asset tracking units fitted to a first asset, the message comprising geographical location data on the first asset generated by the mobile base station asset tracking unit as well as the unique identifier of the mobile base station asset tracking unit fitted to the first asset and the unique identifier of a beacon asset tracking unit fitted to a second asset in the vicinity of the first asset; and
ii. a processor module to extract from the location data message the unique identifier of the beacon asset tracking unit and the geographical location data of the first asset and to associate this information thereby to record the geographical location of the second asset.

2. The system of claim 1 comprising multiple mobile base station asset tracking units, the mobile base station asset tracking units forming a mobile base station network allowing communication between a beacon asset tracking unit and the controlling means when the beacon asset tracking unit is in the vicinity of any one of the mobile base station asset tracking units.

3. The system of claim 1 including a plurality of fixed base stations in communication with the controlling means through the existing communication network and further operable to communicate with a beacon asset tracking unit wirelessly.

4. The system of claim 1 further comprising multiple beacon asset tracking units, each unit comprising a short range communication module operable to transmit its unique identifier to a mobile base station asset tracking unit or a fixed base station when in the vicinity thereof.

5. The system of claim 4 wherein each beacon asset tracking unit is configured to operate in a recovery mode during which distress messages are transmitted to a mobile base station asset tracking unit in its vicinity.

6. The system of claim 5 wherein the location data message includes additional distress information obtained from the distress messages.

7. The system of claim 4 wherein the short range communication module of the beacon asset tracking unit additionally transmits status information to the mobile base station asset tracking unit which status information is to be forwarded to the controlling means.

8. The system of claim 4 wherein the short range communication module is a short range radio frequency transceiver.

9. A mobile base station asset tracking unit to be employed in an asset tracking system and to be fitted to a first asset, the unit including:
a. a first short range communication module to receive from a beacon asset tracking unit, in use fitted to a second asset to be tracked over short range communication, a unique identifier when the second asset is in the vicinity of the first asset;
b. a location module to determine the geographical location of the mobile base station asset tracking unit;
c. a processing module to generate a location data message comprising the geographical location data determined by the location module, as well as a unique identifier of the mobile base station asset tracking unit fitted to the first asset and the unique identifier of a beacon asset tracking unit fitted to a second asset in the vicinity of the first asset; and
d. a second communication module to transmit over an existing communication network the location data message to a control station.

10. A mobile base station module to be fitted to an asset tracking unit employed in an asset tracking system, the unit including:
a. a first short range communication module to receive from a beacon asset tracking unit, in use fitted to a second asset to be tracked over short range communication, a unique identifier when the second asset is in the vicinity of the first asset;
b. an interconnecting module to connect the mobile base station module to the asset tracking unit thereby to obtain geographical location information from a location module of the asset tracking unit; and
c. a processing module to generate a location data message comprising the geographical location data determined by the location module, as well as a unique identifier of the mobile base station asset tracking unit fitted to the first asset and the unique identifier of a beacon asset tracking unit fitted to a second asset in the vicinity of the first asset, which is to be sent transmitted by a communication module of the asset tracking unit over an existing communication network to a control station.

11. The mobile base station module of claim 10 wherein the short range communication module is a short range radio frequency transceiver.

12. The mobile base station module of claim 10 wherein the short range communication module additionally is operable to receive status messages or distress messages from the beacon asset tracking unit which status information is sent to the control station.

13. The mobile base station module of claim 10 wherein the short range communication module is operable to receive distress messages from the beacon asset tracking unit when the unit is in a recovery mode, and to include distress information obtained from the distress messages in the location data message.

14. The mobile base station module of claim 10 wherein the short range communication module is operable to receive a command from the control station which is forwarded to the beacon asset tracking unit to place the beacon asset tracking unit in a recovery mode.

15. The mobile base station module of claim 10 wherein the processing module of the mobile base station asset tracking unit is operable to place the mobile base station asset tracking unit in a recovery mode on receipt of a distress command from the control station, in which mode the short range communication module transmits distress signals to other mobile base station asset tracking units or fixed base stations within its vicinity and/or to other land, mobile or airborne recovery systems.

16. The mobile base station module of claim 10 wherein the short range radio frequency transceiver is operable to transmit polling messages which are received by any beacon asset tracking units in the vicinity of the mobile base station asset tracking unit, in response to which the beacon asset tracking unit is operable to transmit its unique identifier.

17. A method of tracking an asset, the method including:
a. providing a datastore storing asset information including multiple unique identifiers, each identifier being associated with an asset tracking unit in the form of a mobile base station asset tracking unit or a beacon asset tracking unit;
b. receiving over an existing communication network a location data message from one of the mobile base station asset tracking units fitted to a first asset, the message comprising geographical location data on the first asset generated by the mobile base station asset tracking unit as well as the unique identifier of the mobile base station asset tracking unit fitted to the first asset and the unique identifier of a beacon asset tracking unit fitted to a second asset in the vicinity of the first asset; and
c. extracting from the location data message the unique identifier of the beacon asset tracking unit and the geographical location data of the first asset and associating this information, thereby to record the geographical location of the second asset.

18. The method of claim 17 including providing a mobile base station network of multiple mobile base station asset tracking units fitted to the multiple first assets in order to allow communication between the beacon asset tracking unit and a control station via the mobile base station network whenever the beacon asset tracking unit is in the vicinity of any one of the mobile base station asset tracking units.

19. A method of tracking an asset with a mobile base station asset tracking unit to be employed in an asset tracking system and to be fitted to a first asset, the method including:
a. receiving from a beacon asset tracking unit, fitted to a second asset to be tracked over short range communication, a unique identifier when the second asset is in the vicinity of the first asset;
b. determining the geographical location of the mobile base station asset tracking unit;
c. generating a location data message comprising the geographical location data determined by the mobile base station asset tracking unit fitted to the first asset as well as a unique identifier thereof, and the unique identifier of a beacon asset tracking unit fitted to a second asset in the vicinity of the first asset; and
d. transmitting over an existing communication network the location data message to a control station.
